(19) United States
(12) Patent Application Publication
(10) Pub. No.: US 2009/0126567 A1
(43) Pub. Date: May 21, 2009

(54) Mixed Matrix Membranes Containing Molecular Sieves With Thin Plate Morphology

(76) Inventors: Chunqing Liu, Schaumburg, IL (US); Stephen T. Wilson, Libertyville, IL (US); David A. Lesch, Hoffman Estates, IL (US)

Correspondence Address: HONEYWELL INTERNATIONAL INC;PATENT SERVICES, 101 COLUMBIA DRIVE, P O BOX 2245 MAIL STOP AB/2B, MORRISTOWN, NJ, 07962, US

(21) Appl. No.: 11/941,445

(22) Filed: Nov. 16, 2007

(51) Int. Cl. B01D 63/00; B01D 53/22

(52) U.S. Cl. 95/45; 210/500.21; 96/10; 96/11

(57) ABSTRACT

The present invention discloses mixed matrix membranes (MMMs) comprising a polymer matrix and molecular sieve particles and methods for making and using these membranes. The molecular sieve particles contain micropores or mesopores and exhibit a thin plate morphology with high aspect ratio and the plate thickness no more than 300 nm. This invention also pertains to controlling the alignment of the thin plate molecular sieve particles in the continuous polymer matrix of the thin dense selective layer of the asymmetric mixed matrix membranes. These MMMs exhibited much higher selectivity improvement than those comprising molecular sieve particles with other kinds of morphology for gas separations such as CO₂/CH₄ and H₂/CH₄ separations. The thin plate morphology of molecular sieves is beneficial to make high performance mixed matrix membranes. The MMMs are suitable for a variety of liquid, gas, and vapor separations

### BACKGROUND OF THE INVENTION

This invention pertains to mixed matrix membranes (MMMs) comprising a polymer matrix and molecular sieve particles with a thin plate morphology as well as to methods for making and using these membranes.

The feed molecule transport properties of many glassy and rubbery polymers have been measured as part of the search for materials with high permeability and high selectivity for potential use as gas, vapor, and liquid separation membranes. Unfortunately, an important limitation in the development of new membranes is a well-known trade-off between permeability and selectivity of polymers. By comparing the data of hundreds of different polymers, Robeson demonstrated that selectivity and permeability seem to be inseparably linked to one another, in a relation where selectivity increases as permeability decreases and vice versa.

Despite concentrated efforts to tailor polymer structure to improve separation properties, current polymeric membrane materials have seemingly reached a limit in the trade-off between permeability (or permeance) and selectivity. For example, many polyimide and polyetherimide glassy polymers such as Ultem® 1000 have much higher intrinsic CO₂/CH₄ selectivities (α_{CO2/CH4}) (˜30 at 50° C. and 690 kPa (100 psig) pure gas tests) than that of cellulose acetate (˜22), which are more attractive for practical gas separation applications. These polymers, however, do not have outstanding permeabilities attractive for commercialization compared to current commercial cellulose acetate membrane products, in agreement with the trade-off relationship reported by Robeson. On the other hand, some inorganic membranes such as SAPO-34 and DDR zeolite membranes and carbon molecular sieve membranes offer much higher permeability and selectivity than polymeric membranes for separations, but are too brittle, expensive, and difficult for large-scale manufacture. Therefore, it is highly desirable to provide an alternate cost-effective membrane with improved separation properties compared to the polymer membranes.

Based on the need for a more efficient membrane than polymer and inorganic membranes, a new type of membrane, mixed matrix membrane (MMM), has been developed recently. MMMs are hybrid membranes containing inorganic particles such as molecular sieves dispersed in a continuous polymer matrix.

MMMs have the potential to achieve higher selectivity and/or greater permeability compared to the existing polymer membranes, while maintaining their advantages such as low cost and easy processability. Much of the research conducted to date on MMMs has focused on the combination of a dispersed solid molecular sieving phase, such as molecular sieves or carbon molecular sieves, with an easily processed continuous polymer matrix. For example, see U.S. Pat. No. 6,626,980; US 2005/0268782; US 2007/0022877 and U.S. Pat. No. 7,166,146. The sieving phase in a solid/polymer mixed matrix scenario can have a selectivity that is significantly larger than the pure polymer. Therefore, in theory the addition of a small volume fraction of molecular sieves to the polymer matrix will significantly increase the overall separation efficiency. Typical inorganic sieving phases in MMMs include various molecular sieves, carbon molecular sieves, and traditional silica. Many organic polymers, including cellulose acetate, polyvinyl acetate, polyetherimide (commercially Ultem®), polysulfone (commercial Udel®), polydimethylsiloxane, polyethersulfone, and several polyimides (including commercial Matrimid®), have been used as the continuous phase in MMMs.

Most recently, significant research efforts have been focused on materials compatibility and adhesion at the inorganic molecular sieve/polymer interface of the MMMs in order to achieve separation property enhancements over traditional polymers. For example, Kulkarni et al. and Marand et al. reported the use of organosilicon coupling agent functionalized molecular sieves to improve the adhesion at the sieve particle/polymer interface of the MMMs. See U.S. Pat. No. 6,508,860 and U.S. Pat. No. 7,109,140. This method, however, has a number of drawbacks including: 1) prohibitively expensive organosilicon coupling agents; 2) very complicated time consuming molecular sieve purification and organosilicon coupling agent recovery procedures after functionalization. Therefore, the cost of making such MMMs having organosilicon coupling agent functionalized molecular sieves in a commercially viable scale can be very expensive. Most recently, Kulkarni et al. also reported the formation of MMMs with minimal macrovoids and defects by using electrostatically stabilized suspensions. See US 2006/0117949. US 2005/0139065 to Miller et al., entitled “Mixed matrix membranes with low silica-to-alumina ratio molecular sieves and methods for making and using the membranes”, reports the incorporation of low silica-to-alumina (Si/Al) ratio molecular sieves into a polymer membrane with a Si/Al molar ratio of the molecular sieves preferably less than 1.0. Miller et al. claim that when the low Si/Al ratio molecular sieves are properly interspersed with a continuous polymer matrix, the MMM ideally will exhibit improved gas separation performance even without functionalizing the surface of the molecular sieves using organosilicon coupling agent.

While the polymer “upper-bound” curve has been surpassed using solid/polymer MMMs, there are still many issues that need to be addressed to improve separation performance and to produce large-scale MMMs for industrial applications. As an example, most of the molecular sieve/polymer MMMs reported in the literature comprise molecular sieve particles with relatively large particle sizes in the micron range and without morphology control. Commercially available polymer membranes, such as cellulose acetate (CA) and polysulfone membranes, however, have an asymmetric membrane structure with a less than 500 nm thin dense selective layer supported on a porous non-selective layer. As a consequence, the dense selective layer thickness of the mixed matrix membranes is much thinner than the particle size of the molecular sieve particles. Voids and defects, which will result in reduced overall selectivity, are easily formed at the interface of the large molecular sieve particles and the thin polymer matrix of the asymmetric MMMs. Therefore, controlling the thickness of the thin dense selective mixed matrix membrane layer and morphology and the particle size of the molecular sieve particles is critical for making large scale defect-free asymmetric MMMs.

### SUMMARY OF THE INVENTION

This invention pertains to mixed matrix membranes (MMMs) comprising a polymer matrix and molecular sieve particles with a thin plate morphology and methods for making and using these membranes. This invention also pertains to controlling the thickness and alignment of the thin plate molecular sieve particles in the continuous polymer matrix of the thin dense selective layer of the asymmetric mixed matrix membranes.

The MMMs described in the current invention incorporating molecular sieve particles with thin plate morphology have exhibited much higher selectivity improvement than those comprising molecular sieve particles with rod-like, ribbon-like, sphere, pinacoidal, or other kind of morphology compared to the polymer membranes prepared from their corresponding continuous polymer matrices for gas separations such as CO₂/CH₄ and H₂/CH₄ separations.

The MMMs described in the current invention contain a dense selective permeable layer which comprises a continuous polymer matrix and molecular sieve particles with thin plate morphology uniformly dispersed throughout the continuous polymer matrix. The molecular sieves in the MMMs provided in this invention can have selectivity and/or permeability that are significantly higher than the pure polymer membranes for separations. Addition of a small weight percent of molecular sieves to the polymer matrix, therefore, increases the overall separation efficiency significantly. The molecular sieves used in the MMMs of current invention include microporous and mesoporous molecular sieves, carbon molecular sieves, and porous metal-organic frameworks (MOFs) with thin plate morphology. Preferably, the molecular sieve particles described in the current invention have thin plate morphology with an aspect ratio no less than 3 and the plate thickness (or the smallest crystal dimension) no more than 300 nm. The term “aspect ratio” is defined as the ratio of the largest crystalline dimension divided by the smallest crystalline dimension. The term “high aspect ratio” as used in this invention means that the aspect ratio is no less than 3. More preferably, the molecular sieve particles described in the current invention have thin plate morphology with an aspect ratio no less than 5, length of the largest dimension no more than 1000 nm and the thin plate thickness (or the smallest crystal dimension) no more than 200 nm. In addition, the final thickness of the dense selective mixed matrix layer of the MMMs is no less than the thin plate thickness of the molecular sieve particles dispersed in the polymer matrix. Most preferably, nano-sized thin plate molecular sieves or thin plate molecular sieve nanoparticles are used in the MMMs of the current invention. The term “nano-sized thin plate molecular sieves” or “thin plate molecular sieve nanoparticles” as used in this invention means that the thin plate molecular sieves have an aspect ratio no less than 5, length of the largest dimension no more than 500 nm and the thin plate thickness (or the smallest crystal dimension) no more than 100 nm.

The microporous molecular sieves are selected from alumino-phosphate molecular sieves such as AlPO-18, AlPO-14, AlPO-53, and AlPO-17, aluminosilicate molecular sieves such as 4A, 5A, UZM-5, UZM-25, and UZM-9, silico-alumino-phosphate molecular sieves such as SAPO-34, and mixtures thereof. The continuous polymer matrix is selected from glassy polymers such as cellulose acetates, cellulose triacetates, polyethersulfone (PES), sulfonated PES, polysulfone (PSF), sulfonated PSF, polyimides, polyetherimides, polybenzoxazoles, and polymers of intrinsic microporosity.

As an example, poly(DSDA-PMDA-TMMDA))-PES(50:50) polymer membrane prepared from 50 wt-% of poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)) polyimide polymer and 50 wt-% of polyethersulfone (PES) polymer have CO₂ permeability of 10.9 Barrers and CO₂/CH₄ selectivity of 23.2 at 50° C. under 100 psig pure gas pressure. It has been demonstrated that 33% AlPO-14/poly(DSDA-PMDA-TMMDA))-PES(50:50) MMM comprising 33 wt-% of dispersed microporous AlPO-14 molecular sieve particles with pinacoidal morphology and 67 wt-% of a continuous poly(DSDA-PMDA-TMMDA)-PES blend polymer matrix has shown 78% enhancement in CO₂/CH₄ selectivity (from 23.2 to 41.2) compared to poly(DSDA-PMDA-TMMDA))-PES(50:50) polymer membrane. It has been further demonstrated that 33% AlPO-14/poly(DSDA-PMDA-TMMDA))-PES(50:50) MMM comprising 33 wt-% of dispersed microporous AlPO-14 molecular sieve particles with thin plate morphology and 67 wt-% of a continuous poly(DSDA-PMDA-TMMDA)-PES blend polymer matrix has shown 118% enhancement in CO₂/CH₄ selectivity (from 23.2 to 50.5) compared to poly(DSDA-PMDA-TMMDA))-PES(50:50) polymer membrane. This CO₂/CH₄ selectivity improvement is much higher than that of 33% AlPO-14/poly(DSDA-PMDA-TMMDA))-PES(50:50) MMM containing AlPO-14 with pinacoidal morphology. These results have demonstrated that thin plate morphology of molecular sieves is beneficial to make high performance mixed matrix membranes.

The MMMs comprising molecular sieves with thin plate morphology described in the present invention combine the solution-diffusion mechanism of polymer membrane and the molecular sieving and sorption mechanism of molecular sieves. These MMMs assure maximum selectivity and consistent performance among different MMMs comprising the same type of molecular sieves but with other morphologies.

The MMMs comprising molecular sieves with thin plate morphology described in the present invention are in the form of symmetric mixed matrix dense film, asymmetric mixed matrix flat sheet, hollow fiber, or thin-film composite. The approaches of the current invention for producing voids and defects free, high performance MMMs is suitable for large scale membrane production and can be integrated into commercial polymer membrane manufacturing processes.

The invention provides a process for separating at least one gas from a mixture of gases using the MMMs described in the present invention, the process comprising: (a) providing a MMM comprising molecular sieve particles with thin plate morphology uniformly dispersed in a continuous polymer matrix which is permeable to said at least one gas; (b) contacting the mixture on one side of the MMM to cause said at least one gas to permeate the MMM; and (c) removing from the opposite side of the membrane a permeate gas composition comprising a portion of said at least one gas which permeated said membrane.

The MMMs of the present invention are suitable for a variety of liquid, gas, and vapor separations such as deep desulfurization of gasoline and diesel fuels, ethanol/water separations, pervaporation dehydration of aqueous/organic mixtures, CO₂/CH₄, CO₂/N₂, H₂/CH₄, O₂/N₂, olefin/paraffin, iso/normal paraffins separations, and other light gas mixture separations.

### DETAILED DESCRIPTION OF THE INVENTION

Mixed matrix membrane (MMM) containing dispersed molecular sieve fillers in a continuous polymer matrix may retain polymer processability and improve selectivity and/or permeability for separations due to the superior molecular sieving and sorption properties of the molecular sieve materials. The MMMs have received worldwide attention during the last two decades. For most cases, however, the molecular sieve/polymer MMMs reported in the literature comprise molecular sieve particles with relatively large particle sizes in the micron range and without morphology control. Commercially available polymer membranes, such as CA and polysulfone membranes, however, have an asymmetric membrane structure with a less than 500 nm thin dense selective layer supported on a porous non-selective layer. As a consequence, the dense selective layer thickness of the mixed matrix membranes is much thinner than the particle size of the molecular sieve particles. Voids and defects, which will result in reduced overall selectivity, are easily formed at the interface of the large molecular sieve particles and the thin polymer matrix of the asymmetric MMMs. Therefore, controlling the thickness of the thin dense selective mixed matrix membrane layer and morphology and the particle size of the molecular sieve particles is critical for making large scale defect-free asymmetric MMMs.

This invention pertains to novel mixed matrix membranes (MMMs) comprising a polymer matrix and molecular sieve particles with a thin plate morphology and methods for making and using these membranes. This invention also pertains to controlling the thickness and alignment of the thin plate molecular sieve particles in the continuous polymer matrix of the thin dense selective layer of the asymmetric mixed matrix membranes.

The term “mixed matrix” as used herein means that the membrane has a dense selective permeable layer which comprises a continuous polymer matrix and molecular sieve particles uniformly dispersed throughout the continuous polymer matrix. The term “thin plate molecular sieve” as used in this invention means that the molecular sieves have a plate like morphology with high aspect ratio of no less than 3 and the plate thickness (or the smallest crystal dimension) of no more than 300 nm. The terms “nano-sized thin plate molecular sieve” and “thin plate molecular sieve nano-particle” as used in this invention mean that the thin plate molecular sieve has an aspect ratio no less than 5, length of the largest dimension no more than 500 nm and the thin plate thickness (or the smallest crystal dimension) no more than 100 nm. The term “small pore” refers to molecular sieves which have less than or equal to 8-ring openings in their framework structure. The term “micropore” or “microporous” refers to molecular sieves which have pore size no more than 2 nm. The term “mesopore” or “mesoporous” refers to molecular sieves which have pore size from 2 nm to 50 nm.

The MMMs described in the current invention incorporating molecular sieve particles with thin plate morphology have exhibited much higher selectivity improvement than those comprising molecular sieve particles with rod-like, ribbon-like, sphere, pinacoidal, or other kind of morphology compared to the polymer membranes prepared from their corresponding continuous polymer matrices for gas separations such as CO₂/CH₄ and H₂/CH₄ separations.

The MMMs described in the current invention contain a dense selective permeable layer which comprises a continuous polymer matrix and molecular sieve particles with thin plate morphology uniformly dispersed throughout the continuous polymer matrix. The molecular sieves in the MMMs provided in this invention can have selectivity and/or permeability that are significantly higher than the pure polymer membranes for separations. Addition of a small weight percent of molecular sieves to the polymer matrix, therefore, increases the overall separation efficiency significantly. The molecular sieves used in the MMMs of current invention include microporous and mesoporous molecular sieves, carbon molecular sieves, and porous metal-organic frameworks (MOFs) with thin plate morphology.

Molecular sieves improve the performance of the MMM by including selective holes/pores with a size that permits a gas such as carbon dioxide to pass through, but either does not permit another gas such as methane to pass through, or permits it to pass through at a significantly slower rate. The molecular sieves should have higher selectivity for the desired separations than the original polymer to enhance the performance of the MMM. In order to obtain the desired gas separation in the MMM, it is preferred that the steady-state permeability of the faster permeating gas component in the molecular sieves be at least equal to that of the faster permeating gas in the original polymer matrix phase. Molecular sieves have framework structures which may be characterized by distinctive wide-angle X-ray diffraction patterns. Zeolites are a subclass of molecular sieves based on an aluminosilicate composition. Non-zeolitic molecular sieves are based on other compositions such as aluminophosphates, silico-aluminophosphates, and silica. Molecular sieves of different chemical compositions can have the same framework structure.

Zeolites can be further broadly described as molecular sieves in which complex aluminosilicate molecules assemble to define a three-dimensional framework structure enclosing cavities occupied by ions and water molecules which can move with significant freedom within the zeolite matrix. In commercially useful zeolites, the water molecules can be removed or replaced without destroying the framework structure. Zeolite composition can be represented by the following formula: M₂/ₙO:Al₂O₃:xSiO₂:yH₂O, wherein M is a cation of valence n, x is greater than or equal to 2, and y is a number determined by the porosity and the hydration state of the zeolites, generally from 0 to 8. In naturally occurring zeolites, M is principally represented by Na, Ca, K, Mg and Ba in proportions usually reflecting their approximate geochemical abundance. The cations M are loosely bound to the structure and can frequently be completely or partially replaced with other cations or hydrogen by conventional ion exchange. Acid forms of molecular sieve sorbents can be prepared by a variety of techniques including ammonium exchange followed by calcination or by direct exchange of alkali ions for protons using mineral acids or ion exchangers.

Microporous molecular sieve materials are microporous crystals with pores of a well-defined size ranging from about 0.2 to 2 nm. This discrete porosity provides molecular sieving properties to these materials which have found wide applications as catalysts and sorption media. Molecular sieve structure types can be identified by their structure type code as assigned by the IZA Structure Commission following the rules set up by the IUPAC Commission on Zeolite Nomenclature. Each unique framework topology is designated by a structure type code consisting of three capital letters. Exemplary compositions of small pore alumina containing molecular sieves include non-zeolitic molecular sieves (NZMS) comprising certain aluminophosphates (AlPO's), silicoaluminophosphates (SAPO's), metallo-aluminophosphates (MeAPO's), elemental aluminophosphates (ElAPO's), metallo-silicoaluminophosphates (MeAPSO's) and elemental silicoaluminophosphates (ElAPSO's).

To date, almost all of the studies on mixed matrix membranes use large molecular sieve particles with particle sizes in the micron range. See Yong, et al., J. MEMBR. SCI., 188:151 (2001); U.S. Pat. No. 5,127,925; U.S. Pat. No. 4,925,562; U.S. Pat. No. 4,925,459 and US 2005/0043167. Commercially available polymer membranes, such as CA and polysulfone membranes, however, have an asymmetric membrane structure with a less than 500 nm thin dense selective layer supported on a porous non-selective layer. As a consequence, the dense selective layer thickness of the asymmetric mixed matrix membranes is much thinner than the particle size of the molecular sieves. Voids and defects, which result in poor mechanical stability and poor separation performance, are easily formed in these asymmetric MMMs. Nano-sized molecular sieves have been developed recently, which leads to the possibility to prepare defect-free, thin dense selective mixed matrix layer of ≦500 nm. See Zhu, et al., CHEM. MATER., 10:1483 (1998); Ravishankar, et al., J. PHYS. CHEM. B, 102:2633 (1998); Huang, et al., J. AM. CHEM. SOC., 122:3530 (2000). As an example, Brown et al. reported the synthesis of nano-sized SAPO-34 molecular sieve having a cubic-like crystal morphology with edges of less than 100 nm. See Brown et al., US 2004/0082825. Vankelecom et al. reported the first incorporation of nano-sized zeolites in thick symmetric mixed matrix membranes by dispersing colloidal silicalite-1 in polydimethylsiloxane polymer membrane. See Moermans, et al., CHEM. COMMUN., 2467 (2000). Homogeneous symmetric thick polymer/zeolite mixed matrix membranes have also been fabricated by the incorporation of dispersible template-removed zeolite A nanocrystals into polysulfone matrix. See Yan, et al., J. MATER. CHEM., 12:3640 (2002).

Some preferred microporous molecular sieves with thin plate morphology used in the current invention include small pore thin plate molecular sieves with a largest minor crystallographic free diameter of 3.8 angstroms or less such as SAPO-34, Si-DDR, UZM-9, AlPO-14, AlPO-53, AlPO-34, AlPO-17, SSZ-62, SSZ-13, AlPO-18, UZM-5, UZM-25, ERS-12, CDS-1, MCM-65, ZSM-52, MCM-47, 4A, AlPO-34, SAPO-44, SAPO-47, SAPO-17, CVX-7, SAPO-35, SAPO-56, AlPO-52, SAPO-43, medium pore thin plate molecular sieves such as silicalite-1, and large pore thin plate molecular sieves such as NaX, NaY, and CaY.

The microporous molecular sieves with thin plate morphology used in the current invention are capable of separating mixtures of molecular species based on the molecular size or kinetic diameter (molecular sieving mechanism). The separation is accomplished by the smaller molecular species entering the intracrystalline void space while excluding larger species. The kinetic diameters of various molecules such as oxygen (O₂), nitrogen (N₂), carbon dioxide (CO₂), carbon monoxide (CO) and various hydrocarbons are provided in Breck, ZEOLITE MOLECULAR SIEVES, John Wiley and Sons, 1974, p. 636.

The microporous molecular sieves with thin plate morphology used in the current invention improve the performance of the MMM by including selective holes/pores with a size that permits a smaller gas molecule to pass through, but either does not permit another larger gas molecule to pass through, or permits it to pass through at a significantly slower rate.

Another type of molecular sieves used in the MMMs provided in this invention is mesoporous molecular sieves. Examples of preferred mesoporous molecular sieves with thin plate morphology include MCM-41, SBA-15, and surface functionalized MCM-41 and SBA-15, etc.

Metal-organic frameworks (MOFs) can also be used as the molecular sieves in the MMMs described in the present invention. MOFs are a new type of highly porous crystalline zeolite-like materials and are composed of rigid organic units assembled by metal-ligands. They possess vast accessible surface areas per unit mass. See Yaghi et al., SCIENCE, 295: 469 (2002); Yaghi et al., MICROPOR. MESOPOR. MATER., 73: 3 (2004); Dybtsev et al., ANGEW. CHEM. INT. ED., 43: 5033 (2004). MOF-5 is a prototype of a new class of porous materials constructed from octahedral Zn—O—C clusters and benzene links. Most recently, Yaghi et al. reported the systematic design and construction of a series of frameworks (IRMOF) that have structures based on the skeleton of MOF-5, wherein the pore functionality and size have been varied without changing the original cubic topology. For example, IRMOF-1 (Zn₄O(R₁-BDC)₃) has the same topology as that of MOF-5, but was synthesized by a simplified method. In 2001, Yaghi et al. reported the synthesis of a porous metal-organic polyhedron (MOP) Cu₂₄(m-BDC)₂₄(DMF)₁₄(H₂O)₅₀(DMF)₆(C₂H₅OH)₆, termed “α-MOP-1” and constructed from 12 paddle-wheel units bridged by m-BDC to give a large metal-carboxylate polyhedron. See Yaghi et al., J. AM. CHEM. SOC., 123: 4368 (2001). These MOF, IR-MOF and MOP materials exhibit analogous behaviour to that of conventional microporous materials such as large and accessible surface areas, with interconnected intrinsic micropores. Moreover, they may reduce the hydrocarbon fouling problem of the polyimide membranes due to relatively larger pore sizes than those of zeolite materials. MOF, IR-MOF and MOP materials are also expected to allow the polymer to infiltrate the pores, which would improve the interfacial and mechanical properties and would in turn affect permeability. Therefore, these MOF, IR-MOF and MOP materials with thin plate morphology (all termed “MOF” herein this invention) are used as molecular sieves in the preparation of MMMs in the present invention.

Preferably, the molecular sieve particles described in the current invention have thin plate morphology with high aspect ratio no less than 3 and the plate thickness (or the smallest crystal dimension) no more than 300 nm. More preferably, the molecular sieve particles described in the current invention have thin plate morphology with high aspect ratio no less than 5, length of the largest dimension no more than 1000 nm and the thin plate thickness (or the smallest crystal dimension) no more than 200 nm. In addition, the final thickness of the dense selective mixed matrix layer of the MMMs is no less than the thin plate thickness of the molecular sieve particles dispersed in the polymer matrix. Most preferably, nano-sized thin plate molecular sieves or thin plate molecular sieve nanoparticles are used in the MMMs of the current invention.

Selection of nano-sized thin plate molecular sieves for the preparation of MMMs includes screening their dispersity in organic solvent, the porosity, particle size, surface functionality, as well as their adhesion or wetting property with the polymer matrix. The nano-sized thin plate molecular sieves for the preparation of MMMs should have suitable pore size to allow selective permeation of a smaller sized gas, and also should have appropriate particle size in the nanometer range to prevent defects in the membranes. The nano-sized thin plate molecular sieves should be easily dispersed without agglomeration in the polymer matrix to maximize the transport property.

Representative examples of nano-sized thin plate molecular sieves suitable to be incorporated into the MMMs described herein include Si-DDR, AlPO-14, AlPO-34, AlPO-53, AlPO-18, SSZ-62, UZM-5, UZM-9, UZM-25, ERS-12, MCM-65, ZSM-52, CDS-1, and MCM-65 with thin plate morphology.

The MMMs described in the current invention contain a dense selective permeable layer which comprises a continuous polymer matrix and discrete molecular sieve particles uniformly dispersed throughout the continuous polymer matrix. The polymer that serves as the continuous polymer matrix in the MMM of the present invention provides a wide range of properties important for separations, and modifying it can improve membrane selectivity. A material with a high glass transition temperature (Tg), high melting point, and high crystallinity is preferred for most gas separations. Glassy polymers (i.e., polymers below their Tg) have stiffer polymer backbones and therefore let smaller molecules such as hydrogen and helium permeate the membrane more quickly and larger molecules such as hydrocarbons permeate the membrane more slowly. For the MMM applications in the present invention, it is preferred that the membrane fabricated from the pure polymer, which can be used as the continuous polymer matrix in MMMs, exhibits a carbon dioxide over methane selectivity of at least 8, more preferably at least 15 at 50° C. under 690 kPa (100 psig) pure carbon dioxide or methane pressure. Preferably, the polymer that serves as the continuous polymer matrix in the MMM of the present invention is rigid, glassy polymers. The weight ratio of the molecular sieves to the polymer that serves as the continuous polymer matrix in the MMM of the current invention can be within a broad range from about 1:100 (1 weight part of molecular sieves per 100 weight parts of the polymer that serves as the continuous polymer matrix) to about 2:1 (200 weight parts of molecular sieves per 100 weight parts of the polymer that serves as the continuous polymer matrix) depending upon the properties sought as well as the dispersibility of the molecular sieve particles in the particular continuous polymer matrix.

Typical polymer that serves as the continuous polymer matrix in the MMM can be selected from, but is not limited to, polysulfones; sulfonated polysulfones; polyethersulfones (PESs); sulfonated PESs; polyethers; polyetherimides such as Ultem (or Ultem 1000) sold under the trademark Ultem®, manufactured by GE Plastics, poly(styrene)s, including styrene-containing copolymers such as acrylonitrilestyrene copolymers, styrene-butadiene copolymers and styrene-vinylbenzylhalide copolymers; polycarbonates; cellulosic polymers, such as cellulose acetate, cellulose triacetate, cellulose acetate-butyrate, cellulose propionate, ethyl cellulose, methyl cellulose, nitrocellulose; polyamides; polyimides such as Matrimid sold under the trademark Matrimid® by Huntsman Advanced Materials (Matrimid® 5218 refers to a particular polyimide polymer sold under the trademark Matrimid®) and P84 or P84HT sold under the tradename P84 and P84HT respectively from HP Polymers GmbH; polyamide/imides; polyketones, polyether ketones; poly(arylene oxide)s such as poly(phenylene oxide) and poly(xylene oxide); poly(esteramide-diisocyanate); polyurethanes; polyesters (including polyarylates), such as poly(ethylene terephthalate), poly(alkyl methacrylate)s, poly(acrylate)s, poly(phenylene terephthalate), etc.; polysulfides; polymers from monomers having alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl ester)s such as poly(vinyl acetate) and poly(vinyl propionate), poly(vinyl pyridine)s, poly(vinyl pyrrolidone)s, poly(vinyl ether)s, poly(vinyl ketone)s, poly(vinyl aldehyde)s such as poly(vinyl formal) and poly(vinyl butyral), poly(vinyl amide)s, poly(vinyl amine)s, poly(vinyl urethane)s, poly(vinyl urea)s, poly(vinyl phosphate)s, and poly(vinyl sulfate)s; polyalkyl; poly(benzobenzimidazole)s; polyquinoxalines; polybenzothiazoles; polybenzoxazoles; polyhydrazides; polyoxadiazoles; polytriazoles; poly(benzimidazole)s; polycarbodiimides; polyphosphazines; microporous polymers; and interpolymers, including block interpolymers containing repeating units from the above such as interpolymers of acrylonitrile-vinyl bromide-sodium salt of para-sulfophenylmethallyl ethers; and grafts and blends containing any of the foregoing. Typical substituents providing substituted polymers include halogens such as fluorine, chlorine and bromine; hydroxyl groups; lower alkyl groups; lower alkoxy groups; monocyclic aryl; lower acryl groups and the like.

Some preferred polymers that can serve as the continuous polymer matrix include, but are not limited to, polysulfones, sulfonated polysulfones, polyethersulfones, sulfonated PESs, polyethers, polyetherimides such as Ultem (or Ultem 1000) sold under the trademark Ultem®, manufactured by GE Plastics, and available from GE polymerland, cellulosic polymers such as cellulose acetate and cellulose triacetate, polyamides; polyimides such as Matrimid sold under the trademark Matrimid® by Huntsman Advanced Materials (Matrimid® 5218 refers to a particular polyimide polymer sold under the trademark Matrimid®), P84 or P84HT sold under the tradename P84 and P84HT respectively from HP Polymers GmbH, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediamine] (poly(6FDA-m-PDA)), poly[2,2′-bis-(3,4-dicarboxyphenyl)hexafluoropropane dianhydride-1,3-phenylenediamine-3,5-diaminobenzoic acid)] (poly(6FDA-m-PDA-DABA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)); poly[2,2′-bis-(3,4-dicarboxyphenyl)hexafluoropropane dianhydride-2,2-bis(3-amino-4-hydroxyphenyl)-hexafluoropropane] (poly(6FDA-bis-AP-AF)); polyamide/imides; polyketones, polyether ketones; and polymers of intrinsic microporosity.

The most preferred polymers that can serve as the continuous polymer matrix include, but are not limited to, polyimides such as Matrimid®, P84®, poly(BTDA-PMDA-TMMDA), poly(BTDA-PMDA-ODPA-TMMDA), poly(DSDA-TMMDA), poly(BTDA-TMMDA), poly(6FDA-bis-AP-AF), and poly(DSDA-PMDA-TMMDA), polyetherimides such as Ultem®, polyethersulfones, polysulfones, polybenzoxazoles, cellulose acetate, cellulose triacetate, poly(vinyl alcohol)s, and polymers of intrinsic microporosity.

Microporous polymers (or as so-called “polymers of intrinsic microporosity”) described herein are polymeric materials that possess microporosity that is intrinsic to their molecular structures. See McKeown, et al., CHEM. COMMUN., 2780 (2002); Budd, et al., ADV. MATER., 16:456 (2004); McKeown, et al., CHEM. EUR. J., 11:2610 (2005). This type of microporous polymers can be used as the continuous polymer matrix in MMMs in the current invention. The microporous polymers have a rigid rod-like, randomly contorted structure to generate intrinsic microporosity. These microporous polymers exhibit behavior analogous to that of conventional microporous molecular sieve materials, such as large and accessible surface areas, interconnected intrinsic micropores of less than 2 nm in size, as well as high chemical and thermal stability, but, in addition, possess properties of conventional polymers such as good solubility and easy processability. Moreover, these microporous polymers possess polyether polymer chains that have favorable interaction between carbon dioxide and the ethers.

The solvents used for dispersing thin plate molecular sieve particles and dissolving the continuous polymer matrix are chosen primarily for their ability to completely dissolve the polymers and for ease of solvent removal in the membrane formation steps. Other considerations in the selection of solvents include low toxicity, low corrosive activity, low environmental hazard potential, availability and cost. Representative solvents for use in this invention include most amide solvents that are typically used for the formation of polymeric membranes, such as N-methylpyrrolidone (NMP) and N,N-dimethyl acetamide (DMAC), methylene chloride, THF, acetone, isopropanol, octane, methanol, ethanol, DMF, DMSO, toluene, dioxanes, 1,3-dioxolane, mixtures thereof, others known to those skilled in the art and mixtures thereof.

In the present invention, MMMs can be fabricated with various membrane structures such as symmetric mixed matrix dense films, asymmetric flat sheet MMMs, asymmetric thin film composite MMMs, or asymmetric hollow fiber MMMs from molecular sieve/polymer mixed matrix solutions (or dopes) comprising a mixture of solvents, molecular sieve particles with thin plate morphology, and a continuous polymer matrix. The alignment of the thin plate molecular sieve particles in the continuous polymer matrix of the MMMs can be achieved by the shear forces present during thin film casting or fiber extrusion.

In one aspect, the present invention is directed to make symmetric mixed matrix dense films. This approach comprises: (a) dispersing molecular sieve particles with thin plate morphology in an organic solvent or a mixture of two or more organic solvents by ultrasonic mixing and/or mechanical stirring or other method to form a molecular sieve slurry; (b) dissolving a polymer in the molecular sieve slurry to functionalize the surface of molecular sieve particles; In some cases, this step (b) is not necessary; (c) dissolving a polymer or a blend of two polymers that serves as a continuous polymer matrix in the molecular sieve slurry; (d) adding one or more organic solvents that cannot dissolve the polymer matrix to the molecular sieve/polymer slurry and stirring for a certain time to form a stable molecular sieve/polymer casting dope; (e) casting a thin layer of the molecular sieve/polymer casting dope on top of a clean glass plate; (f) evaporating the organic solvents for a certain time; (f) detaching the MMM from the glass plate and drying the MMM at a certain temperature in an vacuum oven to completely remove the residual solvents to form mixed matrix dense film.

In another aspect, the present invention is directed to make defect-free thin-film composite (TFC) MMM by coating a thin layer of molecular sieve/polymer mixed matrix solution on top of a porous support membrane followed by drying the membrane at a certain temperature to remove the organic solvents. The molecular sieve/polymer mixed matrix solution is prepared by: (a) dispersing molecular sieve particles with thin plate morphology in an organic solvent or a mixture of two or more organic solvents by ultrasonic mixing and/or mechanical stirring or other method to form a molecular sieve slurry; (b) dissolving a polymer in the molecular sieve slurry to functionalize the surface of molecular sieve particles; In some cases, this step (b) is not necessary; (c) dissolving a polymer or a blend of two polymers that serves as a continuous polymer matrix in the molecular sieve slurry to form a stable molecular sieve/polymer solution. In some cases a membrane post-treatment step can be added after making the TFC MMM to improve selectivity but does not change or damage the membrane, or cause the membrane to lose performance with time. The membrane post-treatment step can involve coating the top surface of the TFC MMM with a thin layer of material such as a polysiloxane, a fluoro-polymer, a thermally curable silicone rubber, or a UV radiation curable silicone rubber.

In yet another aspect, this invention is directed to make defect-free asymmetric flat sheet MMM using a molecular sieve/polymer mixed matrix casting dope by phase inversion technique. This approach comprises: (a) dispersing molecular sieve particles with thin plate morphology in an organic solvent or a mixture of two or more organic solvents by ultrasonic mixing and/or mechanical stirring or other method to form a molecular sieve slurry; (b) dissolving a polymer in the molecular sieve slurry to functionalize the surface of molecular sieve particles; In some cases, this step (b) is not necessary; (c) dissolving a polymer or a blend of two polymers that serves as a continuous polymer matrix in the molecular sieve slurry; (d) adding one or more organic solvents that cannot dissolve the polymer matrix to the molecular sieve/polymer slurry and stirring for a certain time to form a stable molecular sieve/polymer casting dope; (e) casting a thin layer of the molecular sieve/polymer casting dope on top of a porous fabric support; (f) evaporating the organic solvents for a certain time to form a wet MMM with a thin dense MMM selective layer on the top; (g) immersing the wet MMM into a cold water bath to generate the porous non-selective MMM support layer below the thin dense selective layer by phase inversion; (h) immersing the asymmetric MMM into a hot water bath to remove the residue organic solvents in the MMM; (i) washing and drying the asymmetric MMM at a certain temperature. In some cases a membrane post-treatment step can be added after making the asymmetric MMM to improve selectivity but does not change or damage the membrane, or cause the membrane to lose performance with time. The membrane post-treatment step can involve coating the top surface of the asymmetric MMM with a thin layer of material such as a polysiloxane, a fluoro-polymer, a thermally curable silicone rubber, or a UV radiation curable silicone rubber. The asymmetric flat sheet MMM made using this approach contains a thin dense mixed matrix selective layer supported on a porous non-selective mixed matrix layer.

In yet another aspect, the present invention is directed to make defect-free asymmetric hollow fiber MMM using a molecular sieve/polymer mixed matrix spinning solution by phase inversion technique. This approach comprises: (a) dispersing molecular sieve particles with thin plate morphology in an organic solvent or a mixture of two or more organic solvents by ultrasonic mixing and/or mechanical stirring or other method to form a molecular sieve slurry; (b) dissolving a polymer in the molecular sieve slurry to functionalize the surface of molecular sieve particles; In some cases, this step (b) is not necessary; (c) dissolving a polymer or a blend of two polymers that serves as a continuous polymer matrix in the molecular sieve slurry; (d) adding one or more organic solvents that cannot dissolve the polymer matrix to the molecular sieve/polymer slurry and stirring for a certain time to form a stable molecular sieve/polymer spinning solution; (e) extruding hollow fiber MMM from the stable molecular sieve/polymer spinning solution using a hollow fiber spinning machine; (f) evaporating the organic solvents for a certain time to form a wet hollow fiber MMM with a thin dense MMM selective layer on the surface; (g) immersing the wet hollow fiber MMM into a water bath to generate the porous non-selective pure polymer or MMM support layer below the thin dense selective layer by phase inversion; (h) washing and drying the asymmetric hollow fiber MMM at a certain temperature. In some cases a membrane post-treatment step can be added after making the asymmetric hollow fiber MMM to improve selectivity but does not change or damage the membrane, or cause the membrane to lose performance with time. The membrane post-treatment step can involve coating the selective layer surface of the MMM with a thin layer of material such as a polysiloxane, a fluoro-polymer, a thermally curable silicone rubber, or a UV radiation curable silicone rubber. The asymmetric hollow fiber MMM made using this approach contains a thin dense mixed matrix selective layer on a porous non-selective pure polymer or mixed matrix layer.

The MMMs comprising molecular sieves with thin plate morphology described in the present invention combine the solution-diffusion mechanism of polymer membrane and the molecular sieving and sorption mechanism of molecular sieves. These MMMs assure maximum selectivity and consistent performance among different MMMs comprising the same type of molecular sieves but with other morphologies.

The approaches of the current invention for producing voids and defects free, high performance MMMs is suitable for large scale membrane production and can be integrated into commercial polymer membrane manufacturing processes. The MMMs fabricated by the approaches described in the current invention exhibit significantly enhanced selectivity and/or permeability over polymer membranes prepared from their corresponding polymer matrices.

As an example, Control 1 polymer membrane (described in Example 4) prepared from 50 wt-% of poly(DSDA-PMDA-TMMDA)) polyimide polymer and 50 wt-% of PES polymer have CO₂ permeability of 10.9 Barrers and CO₂/CH₄ selectivity of 23.2 at 50° C. under 100 psig pure gas pressure. It has been demonstrated that MMM 1′ (described in Example 5) comprising 23 wt-% of dispersed microporous AlPO-14 molecular sieve particles with pinacoidal morphology and 77 wt-% of a continuous poly(DSDA-PMDA-TMMDA)-PES blend polymer matrix has shown 42% enhancement in CO₂/CH₄ selectivity (from 23.2 to 32.9 as shown in Table 1) compared to Control 1 polymer membrane. MMM 1″ (described in Example 6) comprising 23 wt-% of dispersed microporous AlPO-14 molecular sieve particles with rod morphology and 77 wt-% of a continuous poly(DSDA-PMDA-TMMDA)-PES blend polymer matrix has shown an enhancement in CO₂/CH₄ selectivity (from 23.2 to 32.4 as shown in Table 1) similar to MMM 1′. It has been further demonstrated that MMM 1 (described in Example 7) comprising 23 wt-% of dispersed microporous AlPO-14 molecular sieve particles with thin plate morphology and 77 wt-% of a continuous poly(DSDA-PMDA-TMMDA)-PES blend polymer matrix has shown higher enhancement in CO₂/CH₄ selectivity (from 23.2 to 36.9 as shown in Table 1) than MMM 1′ and MMM 1″ compared to Control 1 polymer membrane. As another example, MMM 2 (described in Example 8) comprising 33 wt-% of dispersed microporous AlPO-14 molecular sieve particles with thin plate morphology has exhibited much higher improvement in CO₂/CH₄ selectivity (from 23.2 to 50.5 as shown in Table 1) than MMM 2″ (described in Example 9) containing 33 wt-% of AlPO-14 molecular sieve particles with pinacoidal morphology (from 23.2 to 41.2 as shown in Table 1) compared to Control 1 polymer membrane (CO₂/CH₄ selectivity=23.2). These results have demonstrated that thin plate morphology of molecular sieves is beneficial to make high performance mixed matrix membranes.

TABLE 1
Pure gas permeation test results of Control 1, MMM 1,
MMM 1′, MMM 1″, MMM 2, and MMM 2′
for CO₂/CH₄ separation^{a}

| | P_{CO2} | | α_{CO2/CH4} |
|---|---|---|---|
| Membrane | (Barrer)^{b} | α_{CO2/CH4} | Increase |
| Control 1 | 10.9 | 23.2 | 0 |
| MMM 1 | 17.6 | 36.9 | 59% |
| MMM 1′ | 17.2 | 32.9 | 42% |
| MMM 1″ | 15.6 | 32.4 | 40% |
| MMM 2 | 18.3 | 50.5 | 118% |
| MMM 2′ | 20.7 | 41.2 | 78% |

^{a}Tested at 50° C. under 690 kPa (100 psig) pure gas pressure.
^{b}1 Barrer = 10⁻¹⁰ cm³(STP) · cm/cm² · sec · cmHg.

As yet another example, MMM 3 (described in Example 11) comprising 33 wt-% of dispersed microporous AlPO-14 molecular sieve particles with thin plate morphology and 67 wt-% of poly(BTDA-PMDA-ODPA-TMMDA)-PES blend polymer matrix has exhibited significantly improved CO₂/CH₄ selectivity (CO₂/CH₄ selectivity=44.6 as shown in Table 2) compared to Control 2 polymer membrane (described in Example 10, CO₂/CH₄ selectivity=18.8 as shown in Table 2).

TABLE 2
Pure gas permeation test results of Control 2 and
MMM 3 for CO₂/CH₄ separation^{a}

| | | | α_{CO2/CH4} |
|---|---|---|---|
| Membrane | P_{CO2} (Barrer)^{b} | α_{CO2/CH4} | Increase |
| Control 2 | 54.2 | 18.8 | 0 |
| MMM 3 | 65.0 | 44.6 | 137% |

^{a}Tested at 50° C. under 690 kPa (100 psig) pure gas pressure.
^{b}1 Barrer = 10⁻¹⁰ cm³(STP) · cm/cm² · sec · cmHg.

The invention provides a process for separating at least one gas from a mixture of gases using the MMMs described in the present invention, the process comprising: (a) providing a MMM comprising molecular sieve particles with thin plate morphology uniformly dispersed in a continuous polymer matrix which is permeable to said at least one gas; (b) contacting the mixture on one side of the MMM to cause said at least one gas to permeate the MMM; and (c) removing from the opposite side of the membrane a permeate gas composition comprising a portion of said at least one gas which permeated said membrane.

The MMMs of the present invention are especially useful in the purification, separation or adsorption of a particular species in the liquid or gas phase. In addition to separation of pairs of gases, these MMMs may, for example, be used for the separation of proteins or other thermally unstable compounds, e.g. in the pharmaceutical and biotechnology industries. The MMMs may also be used in fermenters and bioreactors to transport gases into the reaction vessel and transfer cell culture medium out of the vessel. Additionally, the MMMs may be used for the removal of microorganisms from air or water streams, water purification, ethanol production in a continuous fermentation/membrane pervaporation system, and in detection or removal of trace compounds or metal salts in air or water streams.

The MMMs of the present invention are especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of CO₂ from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the MMMs described herein. More than two gases can be removed from a third gas. For example, some of the gas components which can be selectively removed from a raw natural gas using the membrane described herein include carbon dioxide, oxygen, nitrogen, water vapor, hydrogen sulfide, helium, and other trace gases. Some of the gas components that can be selectively retained include hydrocarbon gases.

The MMMs described in the current invention are also especially useful in gas/vapor separation processes in chemical, petrochemical, pharmaceutical and allied industries for removing organic vapors from gas streams, e.g. in off-gas treatment for recovery of volatile organic compounds to meet clean air regulations, or within process streams in production plants so that valuable compounds (e.g., vinylchloride monomer, propylene) may be recovered. Further examples of gas/vapor separation processes in which these MMMs may be used are hydrocarbon vapor separation from hydrogen in oil and gas refineries, for hydrocarbon dew pointing of natural gas (i.e. to decrease the hydrocarbon dew point to below the lowest possible export pipeline temperature so that liquid hydrocarbons do not separate in the pipeline), for control of methane number in fuel gas for gas engines and gas turbines, and for gasoline recovery. The MMMs may incorporate a species that adsorbs strongly to certain gases (e.g. cobalt porphyrins or phthalocyanines for O₂ or silver(I) for ethane) to facilitate their transport across the membrane.

These MMMs may also be used in the separation of liquid mixtures by pervaporation, such as in the removal of organic compounds (e.g., alcohols, phenols, chlorinated hydrocarbons, pyridines, ketones) from water such as aqueous effluents or process fluids. A membrane which is ethanol-selective would be used to increase the ethanol concentration in relatively dilute ethanol solutions (5-10% ethanol) obtained by fermentation processes. Another liquid phase separation example using these MMMs is the deep desulfurization of gasoline and diesel fuels by a pervaporation membrane process similar to the process described in U.S. Pat. No. 7,048,846, incorporated by reference herein in its entirety. The MMMs that are selective to sulfur-containing molecules would be used to selectively remove sulfur-containing molecules from fluid catalytic cracking (FCC) and other naphtha hydrocarbon streams. Further liquid phase examples include the separation of one organic component from another organic component, e.g. to separate isomers of organic compounds. Mixtures of organic compounds which may be separated using an inventive membrane include: ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.

The MMMs may be used for separation of organic molecules from water (e.g. ethanol and/or phenol from water by pervaporation) and removal of metal and other organic compounds from water.

An additional application of the MMMs is in chemical reactors to enhance the yield of equilibrium-limited reactions by selective removal of a specific product in an analogous fashion to the use of hydrophilic membranes to enhance esterification yield by the removal of water.

The MMMs described in the current invention have immediate applications for the separation of gas mixtures including carbon dioxide removal from natural gas. The MMM permits carbon dioxide to diffuse through at a faster rate than the methane in the natural gas. Carbon dioxide has a higher permeation rate than methane because of higher solubility, higher diffusivity, or both. Thus, carbon dioxide enriches on the permeate side of the membrane, and methane enriches on the feed (or reject) side of the membrane.

Any given pair of gases that differ in size, for example, nitrogen and oxygen, carbon dioxide and methane, carbon dioxide and nitrogen, hydrogen and methane or carbon monoxide, helium and methane, can be separated using the MMMs described herein. More than two gases can be removed from a third gas. For example, some of the components which can be selectively removed from a raw natural gas using the membranes described herein include carbon dioxide, oxygen, nitrogen, water vapor, hydrogen sulfide, helium, and other trace gases. Some of the components that can be selectively retained include hydrocarbon gases.

### EXAMPLES

The following examples are provided to illustrate one or more preferred embodiments of the invention, but are not limited embodiments thereof. Numerous variations can be made to the following examples that lie within the scope of the invention.

### Example 1

AlPO-14 molecular sieve with thin plate morphology (abbreviated as AlPO-14-thin plate) was prepared. For the synthesis of AlPO-14-thin plate, a suspension with the following chemical composition 1Al₂O₃:1P₂O₅:1tBuNH₂:35H₂O was hydrothermally (HT) treated under tumbled condition at 150° C. for 24 hours. Versal 251 alumina, tertbutylamine template (Aldrich) and DI water were mixed under 1000 rpm vigorous stirring for 1 hour and then the phosphoric acid (85 wt-%, Aldrich) was added very slowly in a drop-wise fashion in order to avoid the suspension to form dense gels. The resulted suspension was stirred for 1.5 hours prior to transferring to a Teflon-lined stainless steel autoclave. The autoclave was then heated in a tumbled oven at 150° C. for 24 hours. After the HT treatment, the crystals were separated from the liquid suspension by filtration. The morphology of the crystals was examined by high resolution scanning electron microscopy (SEM). The crystals were dried at 100° C. for 24 hours. X-ray diffraction patterns and SEM images of the dried powder sample confirmed the formation of pure template-containing AlPO-14 molecular sieve with thin plate morphology.

Template-free AlPO-14 molecular sieve with thin plate morphology was synthesized by calcining the template-containing AlPO-14 molecular sieve powder with thin plate morphology at 600° C. for 6 hours in air atmosphere (heating rate 2° C./min) to form template-free AlPO-14-thin plate (abbreviated as AlPO-14-thin plate).

### Example 2

AlPO-14 molecular sieve with pinacoidal morphology (abbreviated as AlPO-14-pinacoidal) was synthesized. For the synthesis of AlPO-14-pinacoidal, a suspension with the following chemical composition 1Al₂O₃:1P₂O₅:1iPrNH₂:40H₂O was hydrothermally (HT) treated under stirred condition at 175° C. for 48 hours. Versal 251, isopropylamine template (Aldrich) and DI water were mixed under 1000 rpm vigorous stirring for 1 hour and then the phosphoric acid (85 wt-%, Aldrich) was added very slowly in a drop-wise fashion in order to avoid the suspension to form dense gels. The resulted suspension was stirred for 1.5 hours prior to transferring to a stirred reactor. The stirred reactor was then heated at 175° C. for 48 hours. After the HT treatment, the crystals were separated from the liquid suspension by filtration. The morphology of the crystals was examined by high resolution scanning electron microscopy (SEM). The crystals were dried at 100° C. for 24 hours. X-ray diffraction patterns and SEM images of the dried powder sample confirmed the formation of pure template-containing AlPO-14 molecular sieve with pinacoidal morphology.

Template-free AlPO-14 molecular sieve with pinacoidal morphology was synthesized by calcining the template-containing AlPO-14 molecular sieve powder with pinacoidal morphology at 600° C. for 6 hours in air atmosphere (heating rate 2° C./min) to form template-free AlPO-14-pinacoidal (abbreviated as AlPO-14-pinacoidal).

### Example 3

AlPO-14 molecular sieve with rod morphology (abbreviated as AlPO-14-rod) was prepared. For the synthesis of AlPO-14-rod, a milky solution with the following chemical composition 1Al₂O₃:1.5P₂O₅:3iPrNH₂:186H₂O was hydrothermally (HT) treated under static condition at 150° C. for 33 hours. Aluminum tri-sec-butoxide (Aldrich), isopropylamine template (Aldrich) and DI water were mixed under 1000 rpm vigorous stirring for 1 hour and then the phosphoric acid (85 wt-%, Aldrich) was added very slowly in a drop-wise fashion in order to avoid the suspension to form dense gels. The resulted milky solution was stirred for 1.5 hours prior to transferring to a Teflon-lined stainless steel autoclave. The autoclave was then heated in an air-oven at 150° C. for 33 hours. After the HT treatment, the resulted milky suspensions containing AlPO-14 crystals with rod-like morphology were purified by centrifugation in a series of three steps (10,000 rpm for 40 minutes) and re-dispersed in water using an ultrasonic bath. The morphology of the crystals was examined using the re-dispersed water suspension sample and a scanning electron microscopy (SEM). The sample was dried at 100° C. for 24 hours. X-ray diffraction patterns and SEM images of the dried powder sample confirmed the formation of pure template-containing AlPO-14 molecular sieve with rod-like morphology.

Template-free AlPO-14 molecular sieve with rod-like morphology was synthesized by calcining the template-containing AlPO-14 powder with rod-like morphology at 600° C. for 6 hours in air atmosphere (heating rate 2° C./min) to form template-free AlPO-14-rod (abbreviated as AlPO-14-rod).

### Example 4

A “Control” poly(DSDA-PMDA-TMMDA)-PES(50:50) (abbreviated as Control 1) polymer membrane was prepared. 3.0 g of poly(DSDA-PMDA-TMMDA) polyimide polymer and 3.0 g of polyethersulfone (PES) were dissolved in a solvent mixture of NMP and 1,3-dioxolane by mechanical stirring for 2 hours to form a homogeneous casting dope. The resulting homogeneous casting dope was allowed to degas overnight. A Control 1 blend polymer membrane was prepared from the bubble free casting dope on a clean glass plate using a doctor knife with a 20-mil gap. The membrane together with the glass plate was then put into a vacuum oven. The solvents were removed by slowly increasing the vacuum and the temperature of the vacuum oven. Finally, the membrane was dried at 200° C. under vacuum for at least 48 hours to completely remove the residual solvents to form Control 1.

### Example 5

A 23% AlPO-14/poly(DSDA-PMDA-TMMDA)-PES(50:50) mixed matrix membrane comprising 23 wt-% of AlPO-14-pinacoidal (abbreviated as MMM 1′) was prepared. MMM 1′ containing 23 wt-% of dispersed AlPO-14-pinacoidal molecular sieve particles with pinacoidal morphology in poly(DSDA-PMDA-TMMDA) polyimide and PES blend continuous polymer matrix was prepared as follows: 1.8 g of AlPO-14-pinacoidal synthesized in Example 2 were dispersed in a mixture of 11.6 g of NMP and 17.2 g of 1,3-dioxolane by mechanical stirring and ultrasonication for 1 hours to form a slurry. Then 0.6 g of PES was added in the slurry. The slurry was stirred for at least 1 hour to completely dissolve PES polymer. After that, 3.0 g of poly(DSDA-PMDA-TMMDA) polyimide polymer and 2.4 g of PES polymer were added to the slurry and the resulting mixture was stirred for another 2 hours to form a stable casting dope containing 23 wt-% of dispersed AlPO-14-pinacoidal in the continuous poly(DSDA-PMDA-TMMDA) and PES blend polymer matrix. The stable casting dope was allowed to degas overnight.

MMM 1′ was prepared on clean glass plates from the bubble free stable casting dope using a casting knife. The thickness of MMM 1′ was controlled by the gap between the bottom surface of the casting knife and the surface of the glass plate. The film together with the glass plate was then put into a vacuum oven. The solvents were removed by slowly increasing the vacuum and the temperature of the vacuum oven. Finally, the membrane was dried at 200° C. under vacuum for at least 48 hours to completely remove the residual solvents to form MMM 1′.

### Example 6

A 23% AlPO-14/poly(DSDA-PMDA-TMMDA)-PES(50:50) mixed matrix membrane comprising 23 wt-% of dispersed AlPO-14-rod molecular sieve particles with rod morphology in poly(DSDA-PMDA-TMMDA) polyimide and PES blend continuous polymer matrix (abbreviated as MMM 1″) was prepared using similar procedures as described in Example 5, but the molecular sieve used in this example is AlPO-14-rod with rod morphology.

### Example 7

A 23% AlPO-14/poly(DSDA-PMDA-TMMDA)-PES(50:50) mixed matrix membrane comprising 23 wt-% of dispersed AlPO-14-thin plate molecular sieve particles with thin plate morphology in poly(DSDA-PMDA-TMMDA) polyimide and PES blend continuous polymer matrix (abbreviated as MMM 1) was prepared using similar procedures as described in Example 5, but the molecular sieve used in this example is AlPO-14-thin plate with thin plate morphology.

### Example 8

A 33% AlPO-14/poly(DSDA-PMDA-TMMDA)-PES(50:50) mixed matrix membrane comprising 33 wt-% of AlPO-14-thin plate (abbreviated as MMM 2) was prepared using similar procedures as used for making MMM 1 in Example 7, but the loading of AlPO-14-thin plate in this example is 33 wt-%.

### Example 9

A 33% AlPO-14/poly(DSDA-PMDA-TMMDA)-PES(50:50) mixed matrix membrane comprising 33 wt-% of dispersed AlPO-14-pinacoidal molecular sieve particles with pinacoidal morphology in poly(DSDA-PMDA-TMMDA) polyimide and PES blend continuous polymer matrix (abbreviated as MMM 2′) was prepared using similar procedures as used for making MMM 2 in Example 8, but the molecular sieve used in this example is AlPO-14-pinacoidal.

### Example 10

A “Control” poly(BTDA-PMDA-ODPA-TMMDA)-PES(90:10) (abbreviated as Control 2) polymer membrane was prepared from 5.4 g of poly(BTDA-PMDA-ODPA-TMMDA) polyimide polymer and 0.6 g of polyethersulfone (PES) using similar procedures as used in Example 4, but the polymers used in this example are poly(BTDA-PMDA-ODPA-TMMDA) and PES.

### Example 11

A 33% AlPO-14/poly(BTDA-PMDA-ODPA-TMMDA)-PES(90:10) mixed matrix membrane comprising 33 wt-% of AlPO-14-thin plate (abbreviated as MMM 3) was prepared using similar procedures as used for making MMM 2 in Example 8, but the polymers used in this example are poly(BTDA-PMDA-ODPA-TMMDA) and PES.

1. A mixed matrix membrane comprising a continuous polymer matrix and molecular sieve particles dispersed in said continuous polymer matrix wherein a majority of said molecular sieve particles exhibit a thin plate morphology.

2. The mixed matrix membrane of claim 1 wherein said molecular sieve particles are characterized as having a high aspect ratio no less than 3 and a plate thickness no more than 300 nanometers.

3. The mixed matrix membrane of claim 1 wherein said molecular sieve particles are characterized as having a high aspect ratio no less than 5, a length in a largest direction of no more than 1000 nm and a plate thickness no more than 200 nanometers.

4. The mixed matrix membrane of claim 1 having a dense mixed matrix selective layer equal to or greater in thickness than the length of the largest dimension of said molecular sieve particles with thin plate morphology.

5. The mixed matrix membrane of claim 1 wherein said mixed matrix membrane is in a form selected from the group consisting of a symmetric dense film, an asymmetric flat sheet, an asymmetric hollow fiber or a thin-film composite.

6. A process for separating at least one gas from a mixture of gases using a mixed matrix membrane comprising a continuous polymer matrix and molecular sieve particles dispersed in said continuous polymer matrix wherein a majority of said molecular sieve particles exhibit a thin plate morphology, the process comprising: (a) providing a mixed matrix membrane comprising molecular sieve particles with thin plate morphology uniformly dispersed in a continuous polymer matrix which is permeable to said at least one gas; (b) contacting the mixture on one side of the mixed matrix membrane to cause said at least one gas to permeate the mixed matrix membrane; and (c) removing from the opposite side of the mixed matrix membrane a permeate gas composition comprising an increased concentration of said permeate gas compared to said mixture of gases.

7. The process of claim 6 wherein a majority of said molecular sieve particles exhibit a thin plate morphology.

8. The process of claim 6 wherein said molecular sieve particles are characterized as having a high aspect ratio no less than 3 and a plate thickness no more than 300 nanometers.

9. The process of claim 6 wherein said molecular sieve particles are characterized as having a high aspect ratio no less than 5, a length in a largest direction of no more than 1000 nm and a plate thickness no more than 200 nanometers.

10. The process of claim 6 wherein said mixed matrix membrane has a dense mixed matrix selective layer equal to or greater in thickness than the length of the largest dimension of the said molecular sieve particles with thin plate morphology.

11. The process of claim 6 wherein said mixed matrix membrane is in a form selected from the group consisting of a symmetric dense film, an asymmetric flat sheet, an asymmetric hollow fiber or a thin-film composite.

12. A mixed matrix membrane comprising a continuous polymer matrix and discrete molecular sieve particles uniformly dispersed throughout the continuous polymer matrix wherein said molecular sieves exhibit a thin plate morphology.

13. The mixed matrix membrane of claim 12 wherein said molecular sieve particles are characterized as having a high aspect ratio no less than 3 and a plate thickness no more than 300 nanometers.

14. The mixed matrix membrane of claim 12 wherein said molecular sieve particles are characterized as having a high aspect ratio no less than 5, a length in a largest direction of no more than 1000 nm and a plate thickness no more than 200 nanometers.

15. The mixed matrix membrane of claim 12 wherein said mixed matrix membrane has a dense mixed matrix selective layer equal to or greater in thickness than the length of the largest dimension of the said molecular sieve particles with thin plate morphology.

16. The mixed matrix membrane of claim 12 wherein said mixed matrix membrane is in a form selected from the group consisting of a symmetric dense film, an asymmetric flat sheet, an asymmetric hollow fiber or a thin-film composite.

17. The mixed matrix membrane of claim 12 wherein said mixed matrix membrane is used to separate carbon dioxide from natural gas, hydrogen from nitrogen or methane, hydrogen recovery in a refinery, or olefins from paraffins.

18. The mixed matrix membrane of claim 12 wherein said mixed matrix membrane is used to purify natural gas by removing one or more gas components selected from the group consisting of carbon dioxide, oxygen, nitrogen, water vapor, hydrogen sulfide, helium and hydrocarbon gases.

19. The mixed matrix membrane of claim 12 wherein said mixed matrix membrane is used to separate liquid mixtures.

20. The mixed matrix membrane of claim 19 wherein said liquid mixtures are selected from the group consisting of water and organic compounds, isomers of organic compounds, and mixtures of organic compounds.

21. The mixed matrix membrane of claim 20 wherein said mixtures of organic compounds are selected from the group consisting of ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.
